(19) United States
(12) Patent Application Publication
(10) Pub. No.: US 2004/0102888 A1
(43) Pub. Date: May 27, 2004

(54) Device for regulating the dynamics of vehicle movement and a method for aligning vehicle-dynamics sensors

(76) Inventors: Jochen Burgdorf, Offenbach (DE); Karl-Heinz Haupt, Gau-Algesheim (DE); Peter Volz, Darmstadt (DE); Michael Zydek, Frankfurt (DE); Andreas Heise, Morfelden (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/362,111

(22) PCT Filed: Aug. 21, 2001
(86) PCT No.: PCT/EP01/09656

(30) Foreign Application Priority Data
Aug. 22, 2000 (DE) 100 41 206.8
Oct. 18, 2000 (DE) 100 51 811.7
Apr. 9, 2001 (DE) 101 17 640.6

(51) Int. Cl. G06G 7/00

(52) U.S. Cl. 701/70; 701/1

(57) ABSTRACT

The present invention relates to a device for driving dynamics control comprising a valve block (19) and an electronic controller unit (1), wherein electronic components (38) at least for the braking intervention are arranged within the controller unit and process signals of at least one driving dynamics sensor (3, 14, 47), such as a yaw rate sensor and/or acceleration sensor, and wherein at least electrohydraulic valves are arranged in the valve block that is characterized in that at least one driving dynamics sensor is integrated in the device.

Further, the present invention relates to a method of aligning one or more driving dynamics sensors in the above device, comprising the steps of: rotation and/or acceleration of the device into which the sensor is mounted, about one or more determined axes and/or in determined directions, measurement of sensor signals during the rotation or acceleration, calculation of the angular differences between the current sensor axes/directions and the determined axes/directions by comparing the measured sensor signals with the theoretically expected sensor signals, and correction of the misalignment after the installation of the driving dynamics sensors by way of the calculated angular differences by means of a correction means.

The present invention relates to a device according to the preamble of claim 1 and a method according to the preamble of claim 17.

DE 197 55 431 describes a driving dynamics control system wherein a sensor module for driving dynamics sensors, comprising yaw rate sensors and acceleration sensors, is arranged in an electronic housing that is arranged separately of the hydraulic control, and the sensor signals are processed in this housing and the signals needed to actuate the hydraulic unit are produced therein. The hydraulic control unit is connected to the electronic housing by way of a system bus.

DE 198 47 667 A1 describes another device for driving dynamics control with an arrangement of the driving dynamics sensors in a separate housing. According to this publication the driving dynamics sensors, along with a CPU for the brake control, are accommodated in a housing in the area of the center of the vehicle. The power electronics with the valve drivers, however, is integrated in the brake controller that is connected to the CPU by way of an interface.

Beside the above-described devices with an ‘allotted intelligence’, integrated control devices that save space and can be manufactured in a particularly economical fashion are used for driving dynamics control (ESP), but also for ABS, TCS, etc., in many cases. The characteristics for this type of control devices is a compact construction with a monolithic unit composed of electronic controller unit and a valve block, being arranged in the engine compartment of a motor vehicle. The controller unit connected to sensors and actuators of most different type, such as wheel speed sensors, filling level sensors, electromagnetic hydraulic valves, relays, and like components, is essentially used to control/regulate the brakes and to intervene into engine management. The valve block, which is connected to the controller unit by way of a plug device, comprises magnetically operable hydraulic valves for the actuation of the brake cylinders and a flanged pump motor.

The driving dynamics sensor system, comprising acceleration sensors and at least one yaw rate sensor, are nowadays accommodated in the area of the point of gravity of the vehicle either in the form of individual components or grouped and housed in a module with an own processor intelligence (sensor cluster) that is arranged separately of the integrated control device.

However, the arrangement of the driving dynamics sensors in a separate housing with an additional microprocessor for error monitoring and bus processing may be disadvantageous on account of the great safety requirements in modern brake systems. Thus, it is possible that the additionally required microprocessor that is arranged in the separate sensor module or the required transmission device fails. Additional safety provisions must be made as a precaution. Another shortcoming involves that a reliable current supply must be ensured for the sensor cluster, what is also sophisticated and costly. In addition, there is the need to effectively shield the separate housing against electromagnetic radiation in order to avoid faulty sensor signals.

Therefore, an object of the present invention is to provide a device for brake control and driving dynamics control that operates in a particularly reliable and faultless manner.

According to the present invention, this object is achieved by a device as claimed in claim 1.

Some driving dynamics sensors, more particularly all of them, are accommodated within the integrated brake control device or fixed thereto according to the invention. Preferably, the driving dynamics sensor(s) is(are) integrated in the electronic controller unit. It is also feasible, however, to arrange the driving dynamics sensors e.g. in a recess of the valve block.

The term driving dynamics sensors in the invention preferably relates to yaw rate sensors and acceleration sensors, and their sensorially sensitive axes may be aligned respectively towards all possible space axes. However, it may also be suitable that in a driving dynamics control only the yaw rate about the vertical axis of the automotive vehicle is sensed. Thus, the driving dynamics sensors also comprise individual lateral acceleration sensors or longitudinal acceleration sensors. In a particularly preferred manner, the yaw rate sensors sensorially monitor all three space axes. It may be expedient for reasons of the adjusting method described hereinbelow to group only the yaw rate sensor(s) in an assembly that is preferred according to the invention. The acceleration sensors may then be accommodated either directly on the circuit carrier of the electronic controller unit or separately of the controller units, e.g. on another component carrier or in a separate housing.

It is preferred to arrange the driving dynamics sensors on a joint carrier that is connected electrically to a carrier for components of the electronic controller unit.

Besides, the driving dynamics sensors are suitably accommodated in a sensor housing that is closed at least to a major extent and, if necessary, may comprise additional electronic components.

Another embodiment, which is preferred according to the present invention, is composed of an arrangement of the driving dynamics sensors on the components carrier of the electronic controller unit. This possibility is given when misalignments of the driving dynamics sensors are eliminated e.g. by an adjustment of the overall controller unit.

It is imperative for the operation of the device that the driving dynamics sensors are aligned as exactly as possible in the position with respect to the vehicle axles. That means that the axes of the sensor elements with respect to the vehicle axles must be mounted in an alignment that is exactly defined to a large degree, for example, in the simplest case so that the sensor axes coincide with the longitudinal, transverse, or vertical axis of the vehicle.

It is not easily possible by way of narrow limits of the allowable tolerances, to integrate the driving dynamics sensors in a correct position in an automatic manufacturing process for a device of the invention. In contrast thereto, the manufacturing costs may be reduced when the tolerances are extended and a certain number of misalignments after the assembly is tolerated.

Therefore, an adjusting means is provided in the device according to a preferred embodiment of the invention, allowing a practically complete removal of any misalignments of the driving dynamics sensors after the assembly of the device.

Another embodiment solves the problem that brake devices must allow being installed in different alignments, depending on the type of vehicle. To be able to use, if possible, the same device for all vehicle types, according to another preferred embodiment of the invention, accommodation means are provided in the housing of the controller unit or the components carrier, said means permitting an assembly of the driving dynamics sensors in the brake control device without essential modifications to the housing and/or circuit carrier in various predefined installation positions.

The accommodation means preferably predetermines the possible installation positions in the form of a screen, especially by a screen of star-like configuration. The screen may expediently be designed as an indentation or recess in the housing of the controller unit.

The electronic controller unit of the invention preferably comprises a control system based on one or more microprocessors wherein the major part of the control objectives for ESP and ABS is executed.

The electrical connection between the sensor housing or the carrier for driving dynamics sensors and the device for driving dynamics control is favorably effected by means of elastic contact elements, the said device comprising in particular a printed circuit board for the electronic components. However, it is also possible to provide for a plug coupling, especially in the form of a plug socket receiving the sensor module for the connection of such a sensor module. Contacting by means of elastic contact elements may take place in a particularly appropriate manner in the way as has already been described for valve coils in German patent application DE-A 199 404 61.5 which is not published.

In DE-A 199 404 61.5 the coils are connected electrically to the printed circuit board by way of elastic contact elements, with the said contact elements being favorably pressurized and/or force-applied contact elements which are in detachable abutment on matingly configured contacts of the printed circuit board (e.g. metallized surfaces).

In addition, the contact elements may suitably be arranged in their position so as to be movable relative to the contacts, this being done by means of an elastic element or medium, and corresponding elements may at the same time present a guide of the contact elements in particular.

The contact elements most preferably concern springs or flexible conductor foils which are attached in a non-detachable and conductive fashion either to the circuit carrier for the sensor elements or to the printed circuit board of the controller unit.

Suitably, the contact elements may be axially movably arranged in the housing of the controller unit or the sensor assembly.

The contacts arranged on the printed circuit board are advantageously designed as plane, electrically conductive contact zones on the material of the printed circuit board.

The contacting arrangement of the present invention is particularly favorable for the mounting support of the driving dynamics sensors because the sensitive sensor elements are thereby attached especially softly and without vibrations and, in addition, in an electrically safe manner.

The sensor housing and/or the housing of the controller unit and/or the printed circuit board in the controller unit has favorably an electric shielding screen at least in the area of the sensors. A shielding screen may be achieved either by a metallic coating, in particular on the housing material, or by embedding absorbing material such as metal particles into the housing material.

A metal coating appropriate for the shielding screen is obtained in particular by applying a metal layer on the housing material or the material of the printed circuit board, with the housing material and the printed circuit board material being suitably of a non-conductive material.

In a particularly favorable manner, a metallic shielding screen is achieved by the provision of a shielding housing scoop which is produced by coating the inside of a housing cover or by insertion of a metal socket-shaped body.

The above-mentioned shielding screen may advantageously be continued in the layout of the printed circuit board, thereby producing a substantially closed shield envelope around the driving dynamics sensors. The connection between the housing shielding screen and the shielding screen of the printed circuit board may favorably be achieved by a detachable contact.

To simplify the assembly of the electronic controller, the printed circuit board is connected to the electronic controller housing by means of press-in contacts according to a favorable aspect of the invention. Press-in contacts provide an electrical connection to the conductor paths of the printed circuit board without soldering and may be machine-made in a quick and reliable fashion. Due to a large number of individual contacts and suitably shaped abutment means of the controller housing, the printed circuit board is mechanically fixed without additional fixing means exclusively by means of the existing press-in contacts.

In another favorable embodiment, the adjustable fixing means are thermally deformable holders, especially rods.

On account of the protection of the driving dynamics sensors against vibrations, however, the electrical connections of the driving dynamics sensors to the printed circuit board, especially to the printed circuit board of the sensors, may expediently be provided e.g. by means of the spring elements described hereinabove rather than by means of the described contact elements that penetrate the printed circuit board.

In a favorable embodiment electronic filtering means are provided in the invention device, suppressing the undesirable effect of accelerations of the driving dynamics sensors, such as vibrations (caused by the pump motor, valve actuation, etc.). An electronic filtering means may favorably be realized by conditioning the sensor data by means of analogous or digital filters. The filtering operation may also be carried out within a microcontroller.

The present invention also relates to a method according to claim 17 for the alignment of one or more driving dynamics sensors, wherein e.g. the sensor data of installed driving dynamics sensors with misalignments provoked in the manufacturing process are initially measured during rotations executed in a defined way, and the result of measurement is used to correct the misalignment.

In general, three coordinate systems are essential which may be misaligned in relation to each other: (1) The sensory coordinate system with the sensorially sensitive axes, (2) the coordinate system of the readily assembled control device composed of valve block and controller unit, and (3) the coordinate system of the vehicle. It is the objective of the adjustment being made that the sensor data required by the controller unit for the driving dynamics control represent the yaw rates or accelerations along the vehicle axles as precisely

The determined axes about which rotation or displacement initially takes place in a defined manner according to the above method are preferably either the installation axes of the control device or the vehicle axles.

The correction of the misalignment detected according to the invention is preferably effected either by means of an adjusting means of the invention, as described hereinabove, or by means of calculation steps in the arithmetic unit of the electronic controller unit, in particular by an appropriate software, for the correction of the sensor data.

Thus, it is e.g. possible for the arithmetic unit in a learning period to automatically determine misalignments and memorize them and, in a later period during operation of the device, to combine the correction values learnt in the learning period with the measured sensor data in order to compensate the misalignment.

In addition, it may be provided and preferred to filter shocks and vibrations (e.g. caused by the pump or the hydraulic valves) out of the sensor signals in a corresponding fashion electronically by analogous or digital filtering or also by means of an appropriate software so that only those signals that are relevant under driving-dynamics aspects are still processed by the control algorithms.

The method of the present invention may be implemented in a particularly favorable manner when the device comprises more than one, especially three, yaw rate sensors, e.g. for the vertical axis, the lateral axis, and the longitudinal axis.

The sensor data for determining the misalignment, which is acquired during the defined rotations, may favorably originate either directly from the driving dynamics sensors or from additional sensor elements that are specifically destined to determine the misalignment.

Advantageously, the present invention obviates the need for a cable harness for the connection of the sensors, thereby avoiding a large number of sources of errors, e.g. disturbed contacts in electrical plug couplings, that are caused by the cable harness. This fact also permits reducing the expenditure in sophisticated monitoring circuits, e.g. for checking the leakage current, transition resistors in external plug couplings, and the additional monitoring techniques controlled by microprocessors.

Further advantageous embodiments may be taken from the sub claims and the following description of the Figures.

In the drawings,

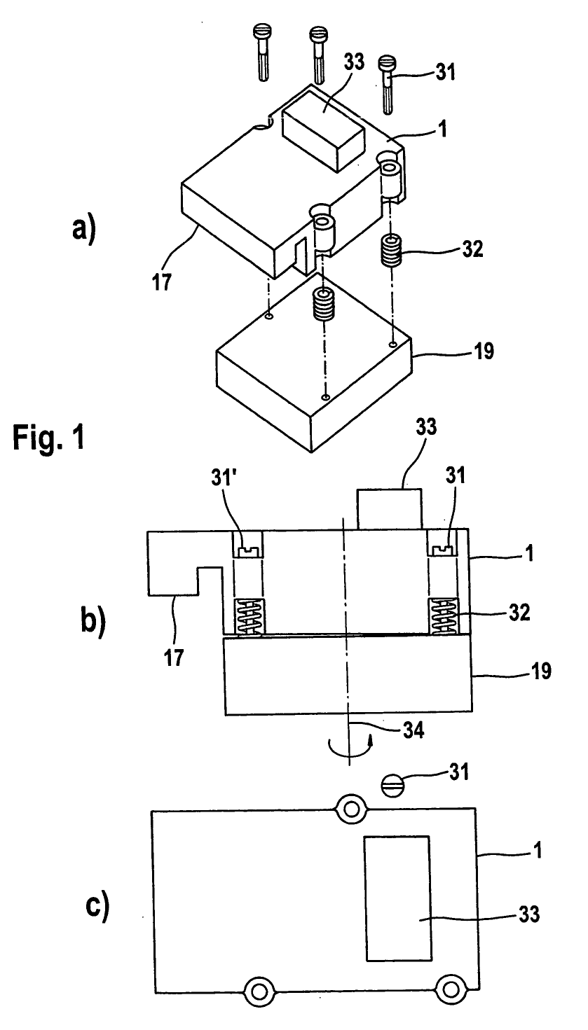

FIG. 1 is a device for driving dynamics control of the present invention.

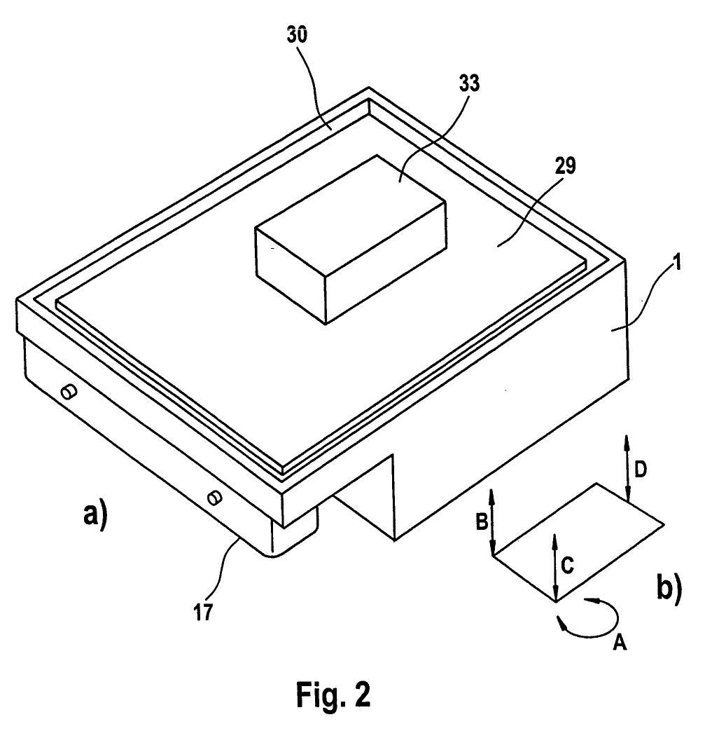

FIG. 2 is an electronic controller unit in a spatially schematic view.

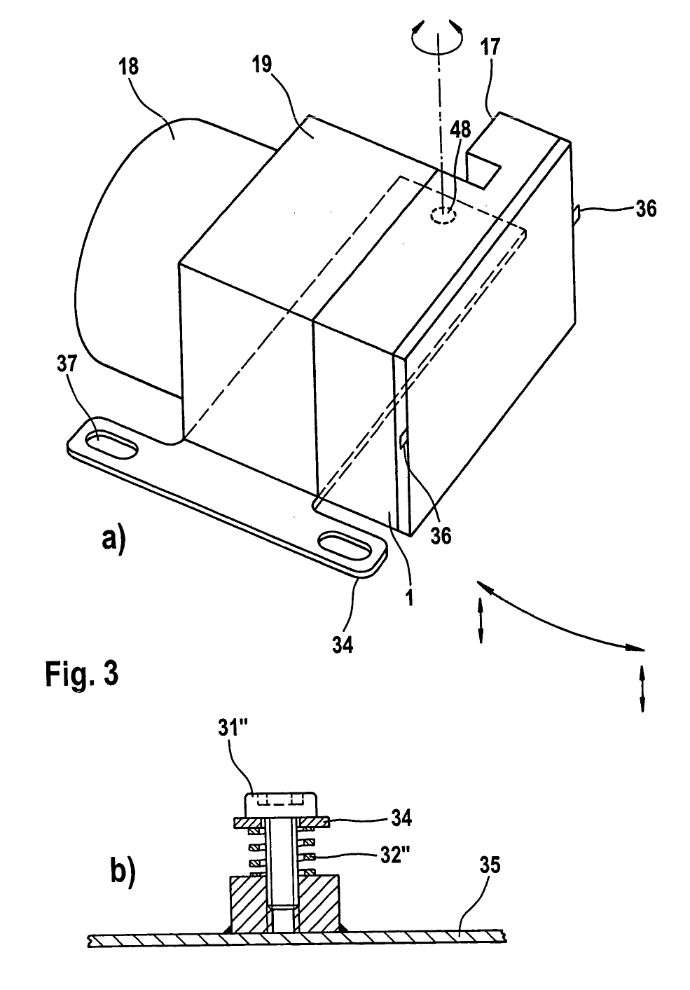

FIG. 3 is an integrated control device with a holder for the adjustment.

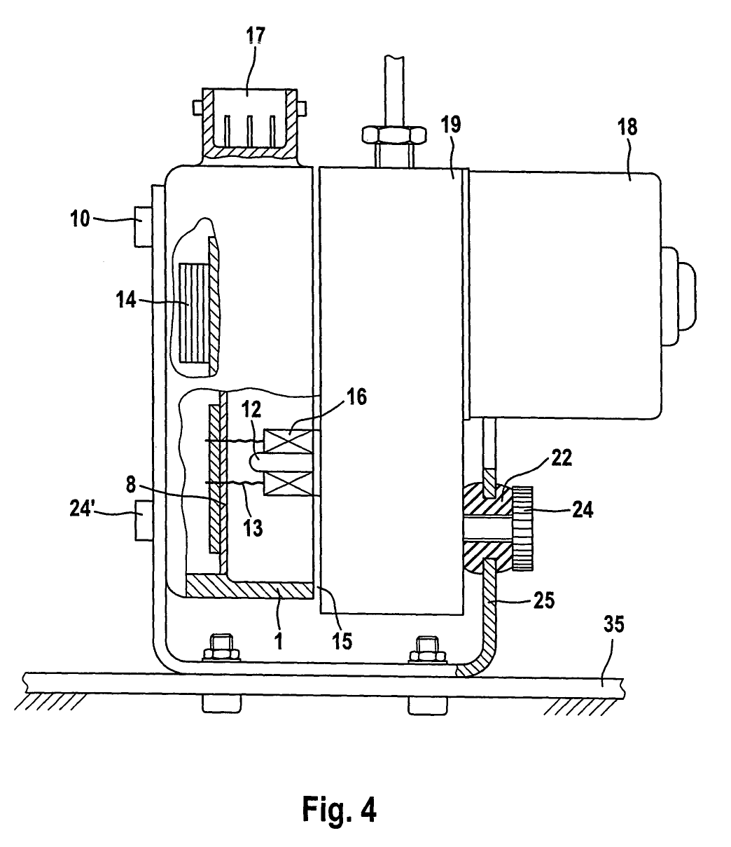

FIG. 4 is another example for an integrated brake device with integrated driving dynamics sensors.

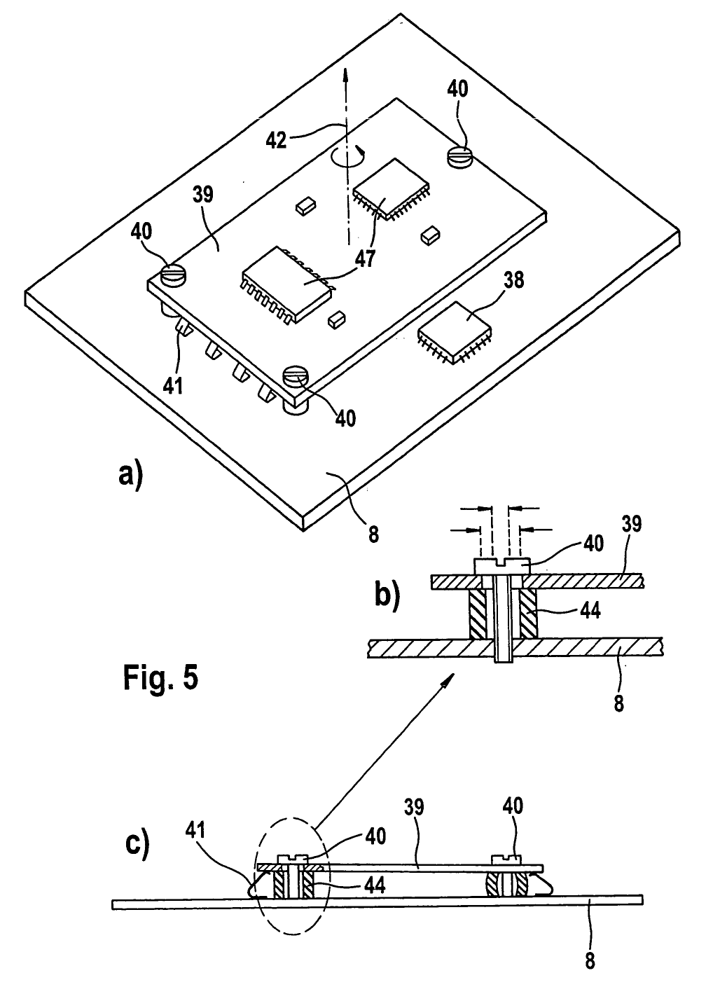

FIG. 5 is a carrier for the driving dynamics sensors according to the present invention.

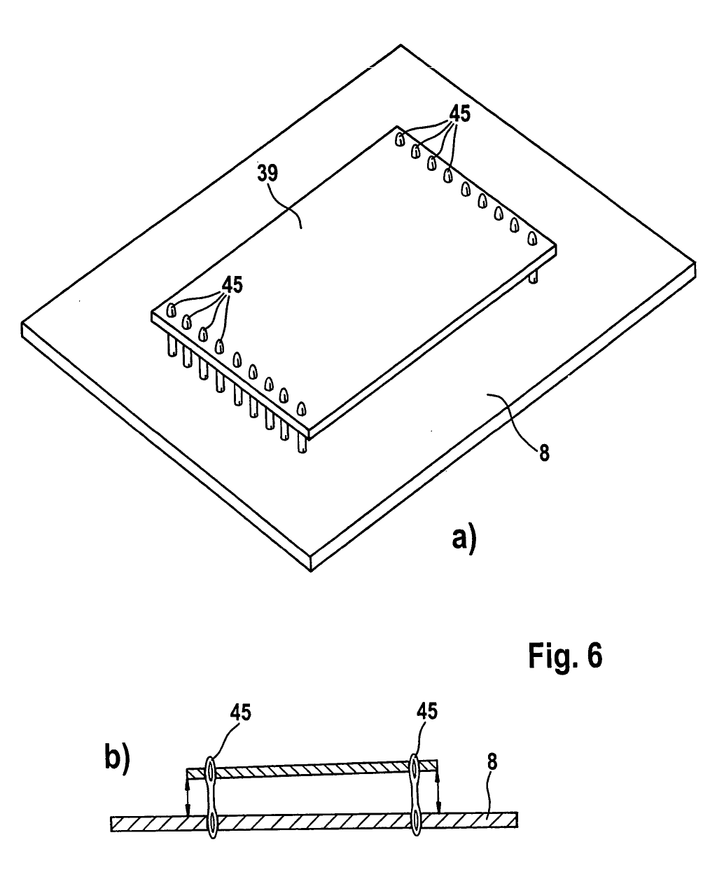

FIG. 6 is an example for an adjustable connection of sensor assembly and printed circuit board by way of press-in contacts.

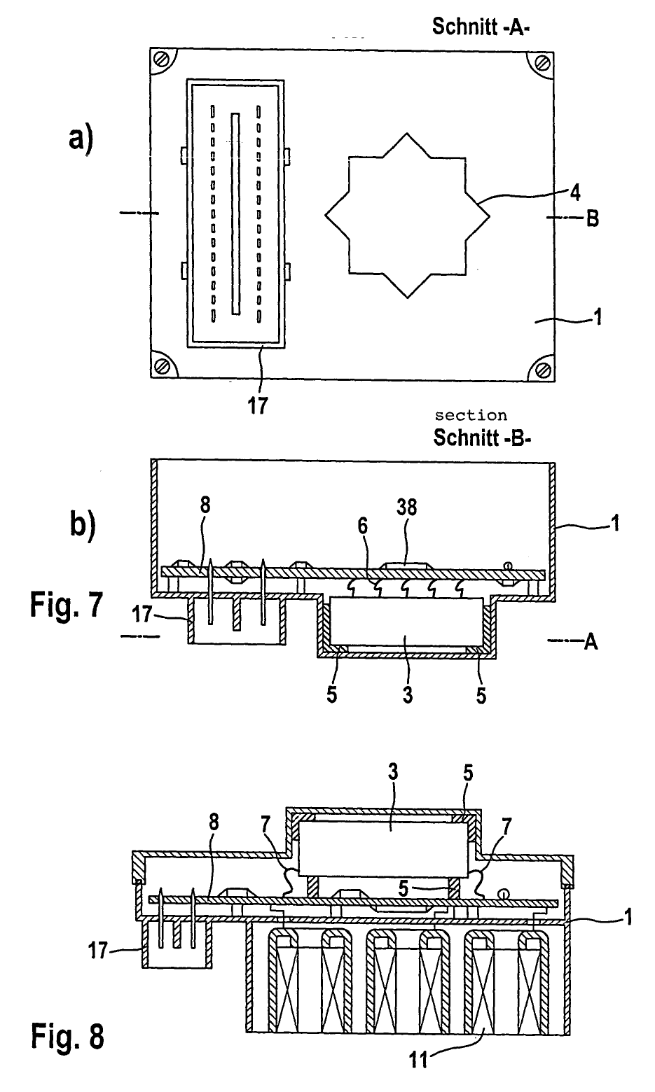

FIG. 7 is an embodiment of an electronic controller unit with an accommodation means.

FIG. 8 is an electronic controller unit with a sensor module installed in a damped fashion.

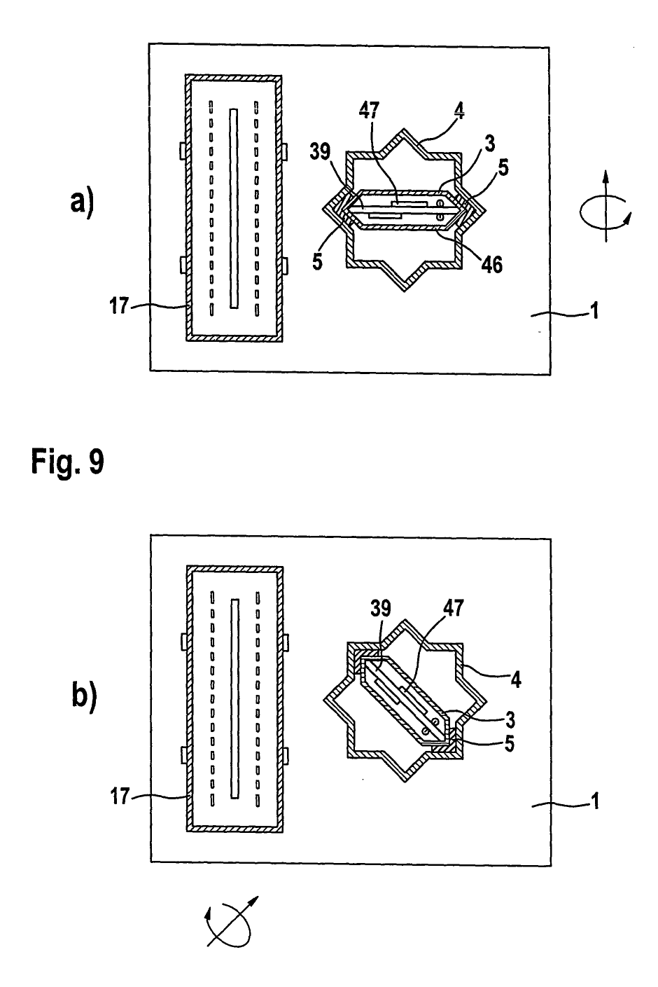

FIG. 9 is an electronic controller unit with an installed sensor assembly.

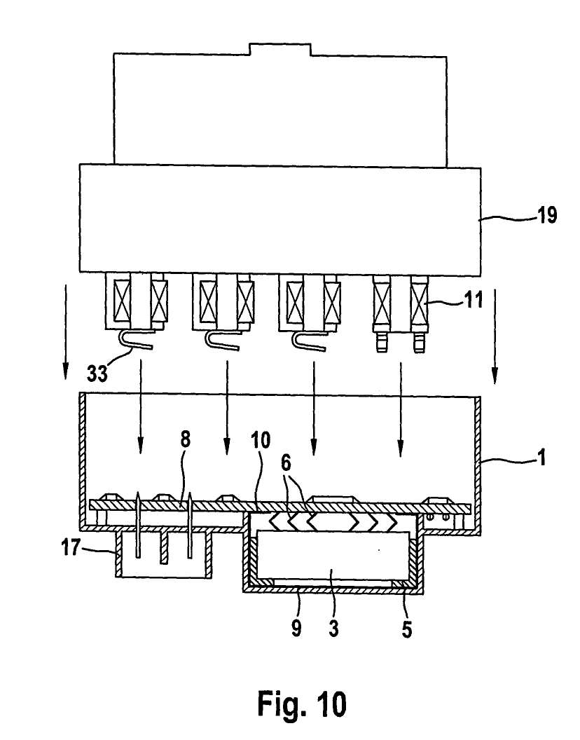

FIG. 10 shows the assembling of an electronic controller unit with a valve block.

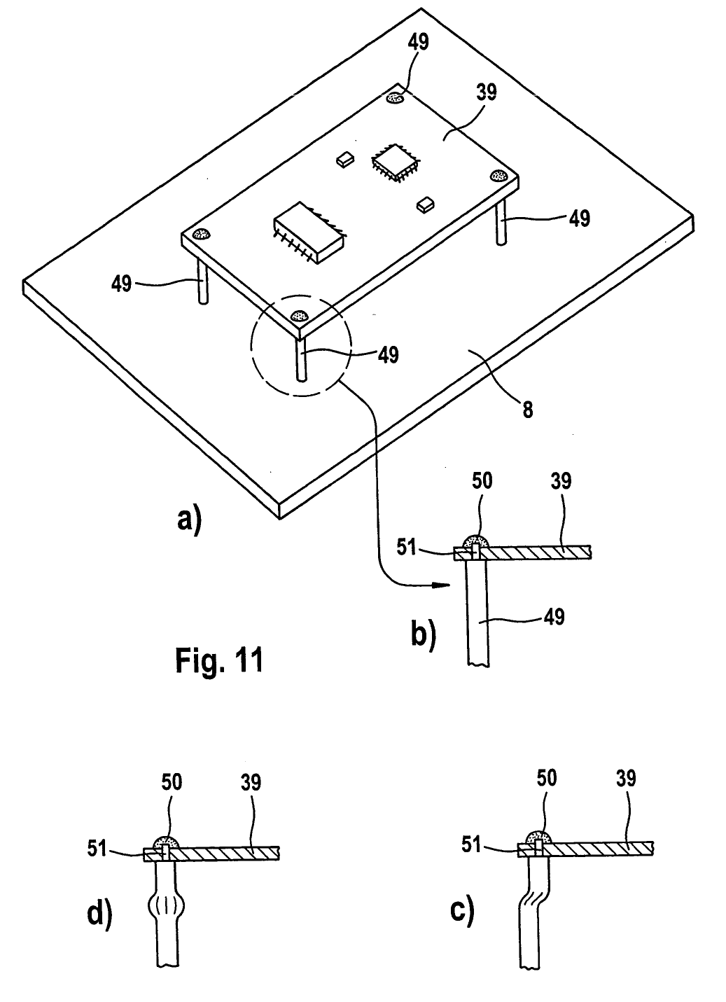

FIG. 11 is another example for the attachment of a sensor carrier to a printed circuit board by means of adjustable fixing means.

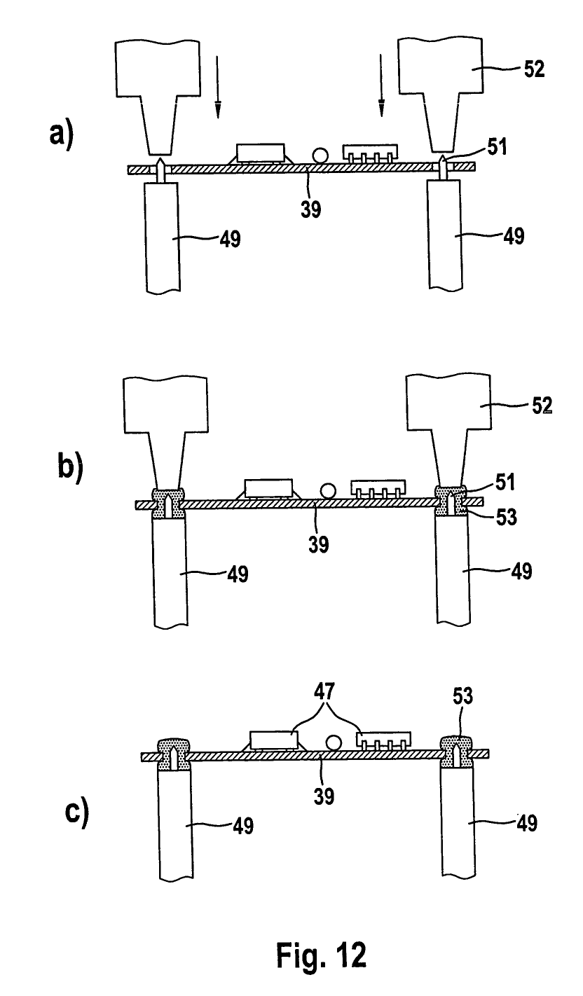

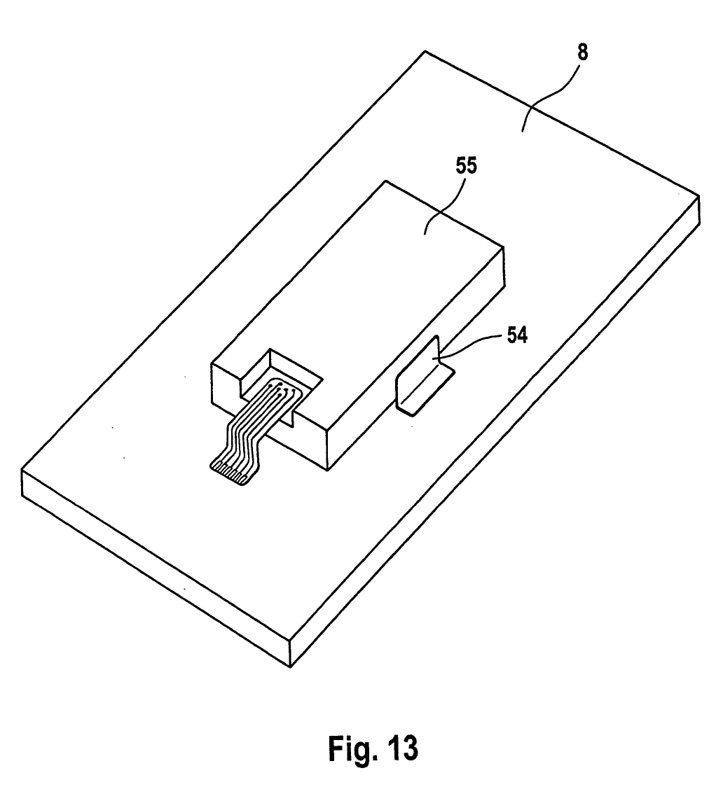

FIG. 12 shows various embodiments for the attachment of a sensor carrier by means of molecular bonds.

FIG. 13 shows the attachment of a sensor carrier by means of plane soldering contacts.

Referring to FIG. 1 an electronic controller unit 1 that can be plugged onto a valve block 19 is represented in a spatial view (a), in a side view (b), and in a top view (c). The valve block is plotted without details (e.g. valves, pump motor) for reasons of simplicity. The housing of the controller unit carries a scoop 33 for accommodating the driving dynamics sensors and comprises an integrated electric plug 17. The housing of the controller unit is attached to the valve block by means of screws 31, with positioning springs 32 being arranged in appropriately shaped recesses of the controller housing. As is shown in partial image b), the alignment of the controller unit relative to the valve block may be adjusted by rotating the screw 31′, for example. Twisting about axis 34 may be performed when the screw diameter is chosen to be smaller than the receiving aperture in the controller housing for the screws and the inside diameter of the springs 32.

As described hereinabove, the electronic controller unit in FIG. 2 may be adjusted with respect to the valve block. The possible adjustment devices are sketched in the partial image b). The controller housing of the controller unit in partial image a) is of two-part design with a cover 29 to which scoop 33 for the accommodation of the sensors is molecularly bonded. Due to the bipartite design of the housing, there may be provided a circumferential space 30 between cover and controller housing permitting an adjustment between cover and controller housing. After the adjustment has been completed, the position can be fixed by means of a molecular bond between the cover and the controller housing.

FIG. 3 shows an integrated control device made up of valve block 19 with flanged pump motor 18 and the electronic controller unit 1, which can be attached by means of a holder 34 in an adjustable manner at appropriate points of abutment of the vehicle body. The alignment of the valve block in relation to the vehicle body is suitably set by means of appropriately rated screws 31″ and positioning springs 32″, with holder 34 including oblong holes 37. Tightening spacer rings may also be used instead of the positioning springs.

To check the installation position, the device of the invention is suitably provided with installation markings that can be applied to the controller housing in particular.

Also, it may be expedient to arrange one or more bores 48 in the controller housing 1, which bores render it possible, e.g. by means of a screw driver, to adjust the sensors with respect to the controller unit within the controller housing after the assembly.

Another example for an integrated brake device is shown in FIG. 4. The driving dynamics sensors are grouped in a subassembly 14 being integrated in the housing or the controller unit. The valve domes 12 projecting from the valve block 19 in the direction of the controller are encompassed by valve coils 16 arranged in the controller unit (magnetic plug). The valve coils are connected to the printed circuit board 8 within the controller by means of elastic, electrically conductive and detachable connections 13.

The transmission of shocks and vibrations onto the driving dynamics sensors, which are likely to be caused by the pump motor and valves and impair the function of the driving dynamics sensors, may be reduced by a damped attachment of the driving dynamics sensors, the controller housing, or the valve block. In the embodiment shown the valve block is elastically suspended at a holder 25 by way of screws 24 and damping elements 22. The holder 25 is rigidly connected to the vehicle body. Holder 25 is additionally used for the attachment of valve block 19, the latter being fastened to the holder by way of screws 24′, with the vibrations not damped. Besides, the electronic controller unit may additionally be uncoupled from the valve block by way of a space 15 which, in the simplest case, is a plane space, but it may also be filled with any suitable material.

FIG. 5 illustrates an invention carrier 39 with sensor components 47 that is adjustably fastened to the printed circuit board 8 for the controller components 38. In partial image a) the alignment can be adjusted within predetermined limits by adjusting and holding screws 40. It is, however, likewise possible to press non-illustrated spikes into the material of the printed circuit board, it being possible also in this case to vary the distance by the indentation depth. Advantageously, the zone beneath the carrier 39 on the printed circuit board 8 may be fitted with electronic components. The electrical connection between sensors and printed circuit board 8 may be by way of resilient contact elements 41.

Partial image b) shows a cross-section of an adjusting and holding screw. An appropriate dimensioning of the bores for the screws also permits an adjustment about the axis of rotation 42 aligned vertically in relation to the printed circuit board.

Partial image c) shows resilient elements that are compressed between the carrier 39 and the printed circuit board 8 by the pressure of the screws 40. The resilient elements may be rubber-like materials 44 or metallic springs, with these materials providing a conductive connection in addition.

In FIG. 6 the carrier 39 for the driving dynamics sensors is connected to the printed circuit board 8 of the electronic controller unit by means of press-in contacts. In this arrangement, the alignment may be adjusted by means of different press-in levels.

The electronic controller unit 1 in FIG. 7 (partial image a) in a top view; partial image b) in a cross-section) is equipped with an accommodation means for the driving dynamics sensors that permits mounting the sensor module 3 in defined installation positions. FIG. 9 shows this embodiment with an installed sensor module 3 for different installation positions according to partial images a) and b). The sensor module comprises a sensor housing 46 with sensor components 47 arranged on a printed circuit board. In the example shown, the accommodations means is a star-like recess 4 of the controller housing into which the sensor module, depending on the alignment desired, can be inserted in a way expediently damped elastically by means of damping elements 5. The contacting of the sensor elements is done in a manner similar to the contacting of the valve coils by way of elastic spring contact elements. The electric plug 17 is led in an upward direction, which is in contrast to the embodiment of FIG. 8.

The assembling operation of joining the valve block 19 and the electronic controller unit 1 is illustrated in FIG. 10. Prior to the assembly the valve coils 11 are plugged onto non-illustrated valve domes that project from the valve block. Fitted to the valve coils are contact elements 13 that are fastened on one side and, after the joining action, establish force-applied, detachable connections with appropriately metallized surfaces on the printed circuit board 8. Contact elements 6 of the sensor module may be designed in a corresponding fashion.

Reference numeral 9 designates metallized surfaces provided for the shielding screen on the housing of the electronic controller unit that is preferably made of plastics. The shielding screen that encompasses the sensor module 3 substantially completely is continued in metallized surfaces 10 made of conductor path material in the area of the printed circuit board.

In FIG. 8 the sensor module 3 is also supported elastically by means of damping elements 5. In contrast to FIG. 7, additional damping elements are arranged between the sensor module and the printed circuit board 8 in FIG. 8. The contacting of the sensors is carried out by way of an elastic conductive connection, e.g. by way of flexible lines, bond wires, flat-wires, etc. Valve coils 11 are arranged in the housing of the controller unit on the side of the printed circuit board opposite the sensor module.

A particularly favorable example of attaching the carrier 39 to the printed circuit board 8 by means of adjustable oblong fixing means 49 is illustrated in FIG. 11, partial image a). Fixing means 49 are made of a material that is thermally deformable to perform the adjustment.

According to partial image b) the thermally deformable rods 49 which accordingly can also be connected to the printed circuit board, are connected to carrier 39 by way of a connecting point 50 made of meltable material or an adhesive, with pin-shaped extensions 51 at the frontal end of the rods being slipped through appropriate bores in an expedient fashion. After solidification of the connecting points 50 the rods 49 are heated so that they soften and are deformable for adjustment within limits predefined by the material. Partial image c) shows a lateral deformation of a rod, partial image d) shows a compression of a rod in a vertical direction.

The adjustment operation is completed because the rods grow cold, thereby fixing the adjusted alignment of the carrier in relation to the printed circuit board.

The necessary electrical connections between carrier and printed circuit board may be constituted by means of flexible conductor paths in a particular suitable fashion in the example shown herein.

FIG. 12 shows an example for a method of the machine-aided assembly of a carrier 39 on the printed circuit board 8, not shown. Initially, a carrier 39 is conveyed by means of a feeding device 52 to the rods 49 connected to the printed circuit board, said feeding device retaining the carrier e.g. by means of a non-illustrated suction apparatus, and subsequently placed on the extensions 51 described above. Thereafter, a thermoplastic, a meltable metallic material 53 is spray-coated by means of a dispenser in such a way that a molecular bond between rods 49 and carrier 39 is produced. It is suitable for the bores provided in the carrier for the accommodation of the extensions 51 to have a larger diameter than the extensions so that the carrier may be adjusted after its attachment by heating the material 53, for example, by using radiant heaters.

When no re-adjustment in the manner described before is performed, it is also possible to use an adhesive as material 53.

FIG. 13 shows another favorable embodiment concerning the attachment of a holder for driving dynamics sensors with printed circuit board 8 of the electronic controller unit. Attachment of the sensor housing 55 is done by means of soldering detachable and adjustable holders, angles 54, or metal sheets being shaped in such a fashion that the sensor module 55 fits into them. Suitably, the surface of the sensor module 55 is coated with a metallic material or consists of such a material. This permits achieving a plane soldering connection to the holders. Adjustment of the sensor module in relation to the printed circuit board 8 can be effected by means of heating the soldered joints and mutual displacement of the surfaces connected by way of the contact surfaces.

1. Device for driving dynamics control comprising a valve block (19) and an electronic controller unit (1), wherein electronic components (38) at least for the braking intervention are arranged within the controller unit and process signals of at least one driving dynamics sensor (3, 14, 47), such as a yaw rate sensor and/or acceleration sensor, and wherein at least electrohydraulic valves are arranged in the valve block,
characterized in that at least one driving dynamics sensor is integrated in the electronic controller unit or the valve block, said sensor being mechanically coupled especially to the housing of the electronic controller unit, or being enclosed by it.

2. Device as claimed in claim 1,
characterized in that there is provision of an adjusting means rendering it possible to correct a misalignment of the driving dynamics sensor(s) in relation to the vehicle axles.

3. Device as claimed in claim 2,
characterized in that the adjusting means is an adjustable fixing means (30, 31, 32, 37, 40, 44, 45, 49) and/or an electronic correction means.

4. Device as claimed in claims 1 to 3,
characterized in that the driving dynamics sensor(s) is(are) arranged on a joint carrier (39) that is connected electrically to a carrier for the components of the electronic controller unit (8).

5. Device as claimed in claim 4,
characterized in that the driving dynamics sensor(s) is(are) accommodated within a sensor housing (3) that is closed at least to a major extent.

6. Device as claimed in at least one of claims 1 to 5,
characterized in that the sensor housing or the carrier for the driving dynamics sensors is inserted into an accommodation means (4) of the housing of the controller unit or the components carrier of the controller unit, said means permitting an accommodation of the driving dynamics sensors in predefined installation positions.

7. Device as claimed in at least any one of claims 1 to 6,
characterized in that the sensor housing or the carrier for the driving dynamics sensors is elastically mechanically fixed in the device for driving dynamics control by means of damping elements (5, 44).

8. Device as claimed in at least any one of claims 1 to 7,
characterized in that the connection between the sensor housing or the carrier for the driving dynamics sensors and the device for driving dynamics controls is provided by means of elastic, electrically conductive contact elements (6) or by means of thermally deformable holders (49).

9. Device as claimed in at least any one of claims 1 to 8,
characterized in that the sensor housing, and/or the housing of the controller unit, and/or the printed circuit board in the controller unit includes an electrical shielding screen (9, 10) at least in the area of the sensors.

10. Device as claimed in at least any one of claims 1 to 9,
characterized in that electronic filtering means are provided, suppressing the effect of undesirable accelerations such as vibrations, etc., on the driving dynamics sensors.

11. Device as claimed in at least any one of claims 1 to 10,
characterized in that the electronic correction means for the adjustment of misalignments are correction algorithms that are implemented in an electronic arithmetic unit of the device.

12. Device as claimed in at least any one of claims 1 to 11,
characterized in that the adjustable fixing means comprise at least one mechanical device for adjusting the alignment out of the group of
devices for the adjustment between valve block and controller unit (31, 32),
devices for the adjustment between valve block and vehicle body (31″, 32″),
devices for the adjustment between sensor housing or carrier for the driving dynamics sensors and controller housing (30), and
devices for the adjustment between sensor housing or carrier for the driving dynamics sensors and a components carrier of the controller unit (40, 44, 45).

13. Device as claimed in claim 12,
characterized in that the device for the adjustment comprises distance-adjusting screw couplings (31, 31″, 32, 32″) and/or level-adjustable, electrically conductive press-in contacts (45) and/or thermally deformable holders (49).

14. Device as claimed in claim 12 or 13,
characterized in that the sensor alignment is finally fixed after the adjustment by means of a molecular bond or by thermoplastic solidification.

15. Device as claimed in at least any one of claims 12 to 14,
characterized in that the distance-adjusting screw couplings comprise rubber elements (44) and/or spring elements (32, 32″).

16. Device as claimed in at least any one of claims 1 to 15,
characterized in that the driving dynamics sensors are uncoupled from the valve block by way of at least one vibration damper (22) for protecting against vibrations of the valve block or the pump motor.

17. Method of aligning one or more driving dynamics sensors, such as yaw rate sensors and/or acceleration sensors, which are integrated into a device for driving dynamics control, in particular as claimed in at least any one of claims 1 to 16, wherein the device is composed of a valve block (19) and an electronic controller unit (1), and electronic components at least for the braking intervention are arranged within the controller unit and process signals of the driving dynamics sensor(s), and wherein the sensorially sensitive axes of the driving dynamics sensors in relation to the vehicle axles may have a misalignment after the installation into a motor vehicle (current sensor installation axes),
characterized by the steps of:
rotation and/or acceleration of the device into which the sensor is mounted, about one or more determined axes and/or in determined directions,
measurement of sensor signals during the rotation or acceleration about these axes and/or directions,
calculation of the angular differences between the current sensor installation axes/directions and the determined axes/directions by comparing the measured sensor signals with the theoretically expected sensor signals, and
correction of the misalignment after the installation of the driving dynamics sensors by way of the calculated angular differences by means of a correction means.

18. Method as claimed in claim 17,
characterized in that the correction means is an adjusting means as claimed in at least any one of claims 3 or 11 to 15.

19. Method as claimed in claim 17,
characterized in that the correction means concerns steps of calculation in the arithmetic unit of the electronic controller unit for the correction of the sensor data.
